(19) United States
(12) Patent Application Publication
(10) Pub. No.: US 2023/0167515 A1
(43) Pub. Date: Jun. 1, 2023

(54) COMPOSITION AND METHOD OF SULFUR-FREE CLARIFICATION OF EXTRACT FROM SUGAR-BEARING PLANTS

(71) Applicant: SOLENIS TECHNOLOGIES, L.P., Wilmington, DE (US)

(72) Inventor: Jonathan Bergamaschi, Wilmington, DE (US)

(73) Assignee: SOLENIS TECHNOLOGIES, L.P., Wilmington, DE (US)

(21) Appl. No.: 18/058,742

(22) Filed: Nov. 24, 2022

Related U.S. Application Data
(60) Provisional application No. 63/264,612, filed on Nov. 29, 2021.

(51) Int. Cl. C13B 20/12

(52) U.S. Cl. CPC C13B 20/123

(57) ABSTRACT

A composition and method for clarification of extract from sugar-bearing plants is provided. In particular, the composition comprises a mixture of one or more natural adsorbing actives and one or more inorganic coagulating or flocculating agents. The composition can be a solid or an aqueous suspension that is added to the aqueous stream of a sugar clarification process used in sugar bearing plants.

### CROSS-REFERENCE TO RELATED APPLICATION

This application claims the benefit of U.S. Provisional application No. 63/264,612, filed Nov. 29, 2021, the entire contents of which are hereby incorporated by reference.

### TECHNICAL FIELD

A composition and method for clarification of extract from sugar-bearing plants is provided. In particular, the composition comprises a mixture of one or more natural adsorbing actives and one or more inorganic coagulating or flocculating agents. The composition can be a solid or an aqueous suspension that is added to the aqueous stream of sugar clarification processes used in sugar bearing plants.

### BACKGROUND

Sugarcane (Saccharum spp.) and its extracts are one of the largest and oldest agricultural crops exploited in countries such as Brazil, assuming great socio-economic importance. It is a culture of great versatility wherein much energy and goods are obtained in the form of bagasse, paper, feed, fertilizer and fuel from leaves, mulch, or animal feed. Other products are obtained from sugarcane extracts, such as sugars, e.g., white sugar, cachaça, ethanol, and brown sugar. Sugarcane extract or juice, is a viscous, opaque, greenish-yellow liquid with a very complex and variable chemical composition that includes sugars, colloids, proteins, pentosans, pectins, fats, gums, waxes, albumins, colloidal silicate, and coloring materials such as chlorophyll and anthocyanins.

The sugarcane extract or juice contains impurities such as pigments and other insoluble materials. The color of sugarcane extract or juice (extract and juice are herein used interchangeably) has its origin in phenolic compounds and flavonoids, among other compounds, that can reflect on the final color of the product. Thus, in the sugarcane mills, the quality of the sugar produced is directly associated with the efficiency of the extract or juice clarification process, since the lack of an effective extract treatment translates into lower quality sugar, with the presence of more color intense impurities and black spots.

In sugar clarification processes, for example in Brazil, the sugar is clarified using a sulfitation process, which has been questioned by food safety standards, due to product quality, sucrose losses during processing, and environmental issues. In the sulfitation of sugarcane extract, sulfur dioxide (SO₂) is obtained by burning elemental sulfur in rotary kilns in the plant itself. This process causes serious environmental problems, such as acid rain, discomfort in the workplace in factories and corrosion of metals in industrial facilities.

The sulfitation process is the most used method in the clarification of sugarcane extracts. Sulphites have been used since ancient times, the Greeks used sulfur dioxide to disinfect their homes; the Romans and Egyptians used them in the sanitization of containers used to store wines. However, as a food preservative, its use dates back to the 17th century, having been approved for use in the USA in the early 1800s. Among the foods that may contain sulfites, alcoholic beverages such as wines and beers are highlighted; bakery items such as biscuits, biscuits and pies, beverages containing sugar or corn syrup, frozen fruit juices; dairy such as curd; crustacean fish and mollusks; fruits such as fresh grapes, dried fruits; gelatins; canned vegetables; sugars such as brown, white sugar.

However, the process has some environmental aspects that have restricted its use. Among these, food safety standards, operational, technological, and environmental issues stand out. Sulfiting agents are classified as food additives and act to inhibit spoilage caused by bacteria, fungi, and yeasts in acidic foods, and to inhibit enzymatic and non-enzymatic browning reactions during processing and storage.

In addition to the issues above, the sulfitation process presents problems of irregularity, operational difficulty, sucrose losses due to working at pH values that reach the range of 3.5-4.0, and due to the solubilization reaction between SO₂, there are variations in the final pH of the resulting sulphited juice and the consequent inversion of sucrose. This leads to lower quality products, including but not limited to, high SO₂ concentration and storage problems.

The sugar manufacturing process aims at extracting the juice contained in sugarcane, its preparation and concentration, culminating in the various types of known sugars, such as: demerara, brown, crystal, refined, liquid and VHP. As previously highlighted, the clarification of some types of sugars is to obtain an extract that is free of impurities. This can involve stages of sieving, chemical treatment, heating, decantation, and filtration of the aqueous extract.

The International Commission for Uniform Methods of Sugar Analysis (ICUMSA), has defined the scale for color grading of white sugars that covers a range from 0 to 6, whereas 0 corresponds to a sugar of maximum whiteness, while 6 indicates a highly colored low grade white sugar. Therefore, the lower the ICUMSA (U.I.) unit, the lighter or whiter the sugar generated. As the ICUMSA color index increases, sugar acquires a darker color.

Therefore, the main purpose of sugarcane juice clarification is to eliminate the maximum amount of impurities present in the sugarcane extract, aiming to obtain a clear, limpid, and shiny juice through the maximum coagulation of colloids and the formation of precipitates that adsorb and carry away the colloidal impurities.

The clarification of sugarcane juice generally occurs in two steps. A first step is a coagulation or, flocculation (used interchangeably throughout this application) and/or precipitation of the colloids and coloring substances found in the sugarcane juice, followed by a step that separates the clarified juice from the colloids and coloring substances through, for example, decantation and filtration techniques.

In the above process, an insoluble material is formed that absorbs and drags impurities from the plant extract. Flocculation results by changing the pH of the medium, using chemical reagents and/or heating of the juice. The clarification of the juice in a sulfitation process involves the steps of sulfitation (countercurrent contact of the juice and SO₂), liming (the juice receives milk of lime) and/or addition of long-chain polymeric compounds, with the juice being heated and decanting and, consequently, formation of the clarified juice that goes to the concentration stage. Two processes of clarification predominate: simple defecation (uses only lime and heating to obtain raw sugar), and sulfo-defecation (before treatment with lime and heating, there is addition of SO₂ to the extract for the manufacture of white crystal sugar).

Simple defecation or liming consists of adding hydrated lime (milk of lime), enough to neutralize the organic acids present in the broth. In general, 500 to 800 g of lime are used per ton of sugarcane, in order to obtain the desired results.

Accordingly, it is desirable to provide compositions and methods for improved clarification of the extract of sugar-bearing plant material while at the same time reducing lime consumption.

Since the process of treating sugarcane extract by sulfitation, intended for the manufacture of sugar and white sugar, pollutes the environment due to the great toxicity of sulfur and its derivatives, other methods of clarifying the extract, juice and syrup have been proposed, in an attempt to reduce the emission of toxic intermediates and aggregates to the final product. The market is increasingly consuming healthier food products, free of pesticides, toxic residues from manufacturing processes and preservatives.

Recently, the search for new technologies for sulfur-free sugarcane juice clarification has been analyzed by several sectors of the sugarcane agroindustry. The use of organic solutions is being explored as sulfur-free alternatives at sugar processing plants and sugar clarification. Other processes involve enzymatic treatment for sugarcane juice clarification. Other processes consists of treating a raw sugarcane juice with a custom-made catalyst comprising of natural adsorbing products, employed at the juice clarification stage for the removal of non-sugar impurities.

In recent studies, what was found was a non-obvious synergy between an inorganic natural adsorbent material, such as an aluminum silicate, with an inorganic coagulating or flocculating agent, such as aluminum salts. Inorganic coagulants and flocculants have the function of neutralizing the negative charges of colored suspended particles or impurities. For example, coagulants based on aluminum chloride have a high concentration of cationic charge, which promoted by the adsorption of aluminum silicate agents, confers synergic coagulating power, thus accelerating the speed in the formation of the impurities, in the form of colloidal colored substances, can effectively be separated from the juice. From the operational point of view, the advantage of using an aluminum salt formulated with an aluminum silicate material brings advantages for the optimization of the treatment process, since there is no need to apply pre-alkalization in the use of coagulant and is effective in a wide pH range (5-10).

Another advantage of using the current innovation when compared to the traditional sulfur-based processes is the reduction in the amount of lime consumption used in clarification processes. It was established that these objects can be achieved with the aid of a complex active substance mixture.

### SUMMARY

Provided is a composition for increased or enhanced clarification of the extract from sugar-bearing plants. In particular, an aqueous sugar-containing composition comprising an adsorbing compound chosen from keiselguhrs, kaolins, zeolites, montminrollites, attapulgites, palygorskites, bentonites, clays, volcanic ash, and combinations thereof; an inorganic coagulating agent; and a plant extract comprising sugar and water.

Also provided is a method for improved clarification of a plant extract comprising sugar and water. The method includes providing the plant extract; and combining the plant extract with an adsorbing compound chosen from keiselguhrs, kaolins, zeolites, montminrollites, attapulgites, palygorskites, bentonites, clays, volcanic ash, and combinations thereof; and an inorganic coagulating agent, to form an aqueous sugar-containing composition. Any insoluble material and impurities can then be separated from sugar and water of the plant extract.

There is also provided an aqueous sugar-containing composition comprising an adsorbing compound chosen from keiselguhrs, kaolins, zeolites, montminrollites, attapulgites, palygorskites, bentonites, clays, volcanic ash, and combinations thereof; an inorganic coagulating agent; a plant extract comprising sugar; and water, wherein the adsorbing compound and the inorganic coagulating agent are combined, and the combination is added to the plant extract.

Finally, there is provided a method for reducing the amount of lime consumption in the clarification of a sugar-bearing plant extract comprising providing a sugar-bearing extract comprising sugar and water. A composition comprising an adsorbing compound selected from keiselguhrs, kaolins, zeolites, montminrollites, attapulgites, palygorskites, bentonites, clays, volcanic ash, and combinations thereof; and an inorganic coagulating agent, is added to the sugar-bearing extract.

### BRIEF DESCRIPTIONS OF THE DRAWINGS

The present method will hereinafter be described in conjunction with the following drawing figures.

FIG. 1—is a box plot of clarification performance which indicates a synergistic effect when the adsorbing compound is combined with the inorganic coagulating agent.

FIG. 2—is a boxplot of clarification between specific mixtures between adsorbing compound combined with the inorganic coagulating agent.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

Provided are compositions and methods for increased or enhanced clarification of the extract from sugar-bearing plants. In particular, provided for is an aqueous sugar-containing composition comprising an adsorbing compound chosen from keiselguhrs, kaolins, zeolites, montminrollites, attapulgites, palygorskites, bentonites, clays, volcanic ash, and combinations thereof an inorganic coagulating agent, a plant extract comprising sugar and water.

In some aspects of the composition, the inorganic coagulating agent can be chosen from an aluminum salt. The aluminum salt can be chosen from aluminum chlorohydrate, aluminum chloride, polyaluminum chloride, and combinations thereof. In some aspects of the method, the inorganic coagulating agent can be polyaluminum chloride.

In some aspects of the composition, the adsorbing compound can be present in an amount of from about 0.03 wt. % to about 1.0 wt. %, of from about 0.1 wt. % to about 0.9 wt. %, or of from about 0.3 wt. % to about 0.6 wt. %, based on a total weight of the composition; and the inorganic coagulating agent can be present in an amount of from about 0.08 wt. % to about 1.0 wt. %, or of from about 0.1 wt. % to about 0.9 wt. %, or of from about 0.3 wt. % to about 0.6 wt. %, based on a total weight of the composition.

In yet other aspects of the composition, the composition is an aqueous suspension and the adsorbing compound can be present in an amount of from about 0.01 wt. % to about 0.6 wt. %, or of from about 0.01 wt. %, to about 0.5 wt. %, or of from about 0.05 wt. % to about 0.3 wt. %, based on a total weight of the composition; and the inorganic coagulating agent can be present in an amount of from about 0.4 wt. % to about 1.0 wt. %, or of from about 0.5 wt. % to about 0.99 wt. %, or of from about 0.6 wt. % to about 0.8 wt. % based on a total weight of the composition.

In yet other aspects, there is a method for improved clarification of a plant extract comprising sugar, water, and impurities in the form of a juice or syrup. The method includes providing the plant extract and combining the plant extract with an adsorbing compound chosen from keiselguhrs, kaolins, zeolites, montminrollites, attapulgites, palygorskites, bentonites, clays, volcanic ash, or combinations thereof; and an inorganic coagulating agent. The impurities can then be separated from the juice through, for example, decantation and filtration.

In some aspects of the method, the inorganic coagulating agent can be chosen from an aluminum salt. The aluminum salt can be chosen from aluminum chlorohydrate, aluminum chloride, polyaluminum chloride, and combinations thereof. In some aspects of the method, the inorganic coagulating agent can be polyaluminum chloride.

In some aspects of the method, the adsorbing compound can be present in an amount of from about 0.03 wt. % to about 1.0 wt. %, of from about 0.1 wt. % to about 0.9 wt. %, or of from about 0.3 wt. % to about 0.6 wt. %, based on a total weight of the composition; and the inorganic coagulating agent can be present in an amount of from about 0.08 wt. % to about 1.0 wt. %, or from about 0.1 wt. % to about 0.9 wt. %, or of from about 0.3 wt. % to about 0.6 wt. %, based on a total weight of the composition.

In yet other aspects of the method, the composition is an aqueous suspension, and the adsorbing compound can be present in an amount of from about 0.01 wt. % to about 0.6 wt. %, or of from about 0.01 wt. %, to about 0.5 wt. %, or of from about 0.05 wt. % to about 0.3 wt. %, based on a total weight of the composition; and the inorganic coagulating agent can be present in an amount of from about 0.4 wt. % to about 1.0 wt. %, or of from about 0.5 wt. % to about 0.99 wt. %, or of from about 0.6 wt. % to about 0.8 wt. % based on a total weight of the composition.

In yet other aspects, there is an aqueous sugar-containing composition comprising an adsorbing compound chosen from keiselguhrs, kaolins, zeolites, montminrollites, attapulgites, palygorskites, bentonites, clays, volcanic ash, and combinations thereof; an inorganic coagulating agent; a plant extract comprising sugar; and water, wherein the adsorbing compound and the inorganic coagulating agent are combined, and the combination is added to the plant extract.

In some aspects of the composition, the inorganic coagulating agent being combined with the adsorbing compound can be chosen from an aluminum salt. The aluminum salt can be chosen from aluminum chlorohydrate, aluminum chloride, polyaluminum chloride, and combinations thereof. In some aspects of the composition, the inorganic coagulating agent can be polyaluminum chloride.

In some aspects of the composition, the adsorbing compound being combined with the inorganic coagulating agent can be in an amount of from about 0.03 wt. % to about 1.0 wt. %, of from about 0.1 wt. % to about 0.9 wt. %, or of from about 0.3 wt. % to about 0.6 wt. %, based on a total weight of the composition; and the inorganic coagulating agent can be present in an amount of from about 0.08 wt. % to about 1.0 wt. %, or of from about 0.1 wt. % to about 0.9 wt. %, or of from about 0.3 wt. % to about 0.6 wt. %, based on a total weight of the composition.

In yet other aspects of the composition, the adsorbing compound and inorganic coagulating agent can be an aqueous suspension when combined and the adsorbing compound can be present in an amount of from about 0.01 wt. % to about 0.6 wt. %, or of from about 0.01 wt. %, to about 0.5 wt. %, or of from about 0.05 wt. % to about 0.3 wt. %, based on a total weight of the composition; and the inorganic coagulating agent can be present in an amount of from about 0.4 wt. % to about 1.0 wt. %, or of from about 0.5 wt. % to about 0.99 wt. %, or of from about 0.6 wt. % to about 0.8 wt. % based on a total weight of the composition.

In still other aspects, there is a method for reducing the amount of lime consumption in the clarification of a sugar-bearing plant extract comprising providing a sugar-bearing extract comprising sugar and water; adding to the sugar-bearing extract a composition comprising: an adsorbing compound chosen from keiselguhrs, kaolins, zeolites, montminrollites, attapulgites, palygorskites, bentonites, clays, volcanic ash, and combinations thereof; and an inorganic coagulating agent.

In other aspects of the method for reducing lime, the amount of lime consumption is reduced by at least 50%, or at least 55%, or at least 60%, when compared with the consumption of lime using a sulfitation process.

### EXAMPLES

Clarification experiments were carried out using a sulfitation process as a benchmark of sugarcane extract clarification performance. As sugarcane has a lot of variation in composition between samples from different lots, the percentage of clarification was used as a response variable as a function of the benchmarking through sulfitation.

It is known that diphosphorus pentoxide plays a role in clarification processes. Free diphosphorus pentoxide reacts with residual lime in sugarcane extracts resulting in tricalcium phosphate Ca₃(PO₄)₂ being deposited along with other impurities. According to studies, P₂O₅ levels may vary between 70 to 1000 mgL⁻¹. However, in sugarcane clarification, the P₂O₅ levels are typically tried to be maintained at about 300 to about 350 mgL⁻¹. When this value drops below the minimum desired value, an extra amount of diphosphorus pentoxide is added until the active level reaches from about 300 to about 350 mgL⁻¹ or whatever the desired level is. The experimental procedure to determine the initial amount of P₂O₅ in samples of sugarcane extract is shown below:

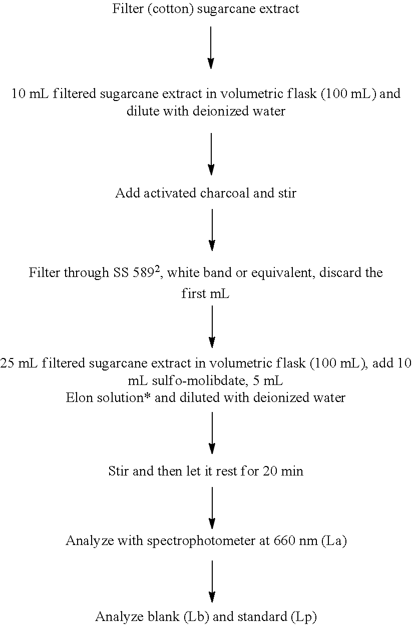

The formula below is used for calculating the amount of P₂O₅ in the sample:

$$mg P / l = 200 \times \frac{( L a - L b )}{( L p - L b )} mg P 2 O 5 / l = 458 \times \frac{( L a - L b )}{( L p - L b )}$$

wherein results are given as mg of Phosphorus/Liter (P/I) where:

La is the Sample reading;

Lb is the Blank reading; and

Lp is the Standard reading.

In order to standardize the clarification responses, the SO₂ clarification level was used as a benchmarking and all samples clarification results were normalized to the benchmark. That is, a mean of “1” corresponds to the level of clarification obtained by the industry today (SO₂). See summary below:

Result “1” is the benchmark clarification performance [SO₂ 0.03% (m/v)].

Result “>1” the candidate was better than benchmark.

Result “<1” the candidate was worse than benchmark.

Therefore, the closer the results were to 1.0, the closer the sample was to the benchmarking performance of sulfitation. To calculate the ICUMSA color of the raw sugarcane extract and clarified extracts, the syrups were diluted in 5 and 10% respectively and their pH was corrected to 7.0±0.1. The samples were filtered through a PVDF membrane with a pore diameter of 0.45 μm and sonicated. The samples were analyzed to determine the solvable solids using a refractometer (Model: ACATEC model RDA 5000), in which the results were presented in Brix and fed into a colorimeter (Model: COLOROMAT S, Schmidt+Haensch GmbH & Co., Berlin, Germany) at wavelength to 420 nm and optical length of the cell to 1 cm.

### Example 1

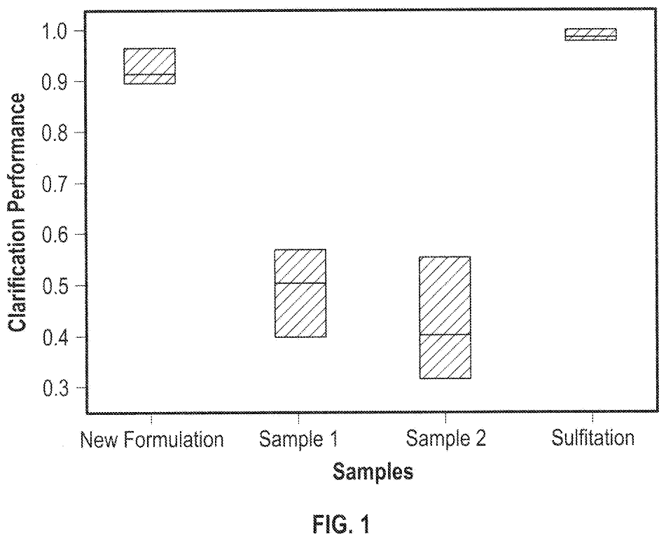

This clarification study was accomplished as outlined above wherein the following compositions were added to the sugarcane extract and compared with the clarification using a sulfitation process: (1) aluminum silicate and an aluminum salt; (2) aluminum salt alone; and (3) aluminum silicate alone. Results can be seen in Table 1 and FIG. 1, which indicates a synergistic effect is seen when the adsorbing compound is combined with the inorganic coagulating agent.

TABLE 1
Clarification of Adsorbent Compound Alone and with Coagulating Agent

| | Sample | Dosage | Avg. | Std. | Individual 95% |
|---|---|---|---|---|---|
| Sample Type | Size | ppm | Clarification | Deviation | CI for Mean |
| Sulfitation Process | 5 | 300 | 0.999 | 0.00707 | (0.98122; 0,99878) |
| (New Formulation) | 5 | 300 | 0.962 | 0.03564 | (0.91775; 1,0062) |
| Aluminum Silicate + | | | | | |
| Polyaluminum Chloride | | | | | |
| Sample 1 | 5 | 300 | 0.486 | 0.08649 | (0.37861; 0.59339) |
| Polyaluminum Chloride | | | | | |
| Sample 2 | 5 | 300 | 0.428 | 0.12215 | (0.27633; 0.57967) |
| Aluminum Silicate | | | | | |

### Example 2

This study was accomplished using ten different adsorbing compounds to determine their clarifying and adsorbent properties: (1) Bentonite NA-35 (Bentonita); (2) Clarigel™ 215AA (activated clay); (3) Clarigel™ 250AA (aluminum/magnesium silicate); (4) Diatomite BS 5 (diatomaceous earth); (5) Perlite MF 1100 (volcanic ash); (6) Perlite MF 300 (volcanic ash); (7) Perlite 100 (volcanic ash); (8) Perlite 200 (volcanic ash); (9) Polenita Extra (bentonite); (10) Radiolite 600 (diatomaceous earth).

The samples listed above, were tested in triplicate or quadruplicate at a dosage of 1% w/w. Table 2, shows the statistical results that each sample had on the clarification of the sugarcane extract.

TABLE 2
Statistical Results of Clarification of
Sugarcane Extract at a dosage of 1% w/w.

| | | | Standard |
|---|---|---|---|
| Samples | Sample Size | Mean | Deviation |
| (1)—Bentonite NA-35 | 3 | 0.98967 | 0.07391 |
| (2)—Clarigel ™ 215AA | 4 | 0.905 | 0.02978 |
| (3)—Clarigel ™ 250AA | 3 | 0.653 | 0.00721 |
| (4)—Diatomite BS 5 | 3 | 0.658 | 0.21912 |
| (5)—Perlite MF1100 | 3 | 0.74767 | 0.25872 |
| (6)—Perlite MF300 | 3 | 0.59667 | 0.04922 |
| (7)—Perlite 100 | 3 | 0.78867 | 0.05093 |
| (8)—Perlite 200 | 4 | 0.61 | 0.14021 |
| (9)—Polenita Extra | 3 | 0.669 | 0.14592 |
| (10) Radiolite 600 | 3 | 0.86867 | 0.13715 |

It is important to note that Bentonite NA-35 performed the best while Perlite MF300, although showing clarification properties, did not perform as well as some of the others.

Among the Samples tested in the study at a dosage of 1% m/m in 200 g of sugarcane extract, three samples/formulations provided better clarification than the other samples, i.e. (1) Bentonite NA 35 (mean=0.989±0.074); (2) Clarigel™ 215 AA (mean=0.905±0.030) and (10) Radiolite 600 (mean=0.869±0.137) with regard to clarification and lime reduction consumption study. These three samples were chosen for additional studies.

### Example 3

The samples that provided the best results in Example 2, i.e. Bentonite NA 35 and Clarigel™ 215 AA at 1.0% w/w, were tested as mixtures for possible synergism. In this study, a pH regulator (Calcium oxide) and coagulation aid Polyaluminum Chloride (PAC) were used in various proportions, the composition being added to the sugarcane extract at a dosage of 0.1% w/w. Results can be found in Table 3.

TABLE 3
Clarification of Sugarcane Extract-Adsorbent Mixtures
Compared to Sulfitation Process at 0.1% w/w.

| | | | | ICUMSA % | |
|---|---|---|---|---|---|
| | | | % | Clarifi- | Clarifi- |
| | | % | Clarifi- | cation | cation |
| | | w/w | cation | Sample | Vs |
| Sample | % w/w Mixtures | Dosage | vs SO₂ | vs SO₂ | SO₂ |
| A | Bentonite NA-35/ | 0.1 | 48.38 | 31.57 | 0.652 |
| | Clarigel ™ 215 | | | | |
| | (50/50) | | | | |
| B | Bentonite NA-35/ | 0.1 | 48.38 | 18.69 | 0.386 |
| | Clarigel ™ 215/ | | | | |
| | Calcium Oxide | | | | |
| | (50/40/10) | | | | |
| C | Bentonite NA-35/ | 0.1 | 52.20 | 32.46 | 0.622 |
| | Clarigel ™ 215/ | | | | |
| | Calcium Oxide/ | | | | |
| | Alupol ® | | | | |
| | (50/30/10/10) | | | | |
| D | Bentonite NA-35/ | 0.1 | 50.43 | 26.24 | 0.520 |
| | Clarigel ™ 215 | | | | |
| | (90/10) | | | | |
| E | Bentonite NA-35/ | 0.1 | 50.43 | 29.57 | 0.586 |
| | Clarigel ™ 215/ | | | | |
| | Alupol ® | | | | |
| | (80/10/10) | | | | |
| F | Bentonite NA-35/ | 0.1 | 47.63 | 47.63 | 0.909 |
| | Alupol ®(50/50) | | | | |

Among the mixtures at dosage 0.1% w/w, Sample F, performed the best with an average of 0.909±0.069.

### Example 4

The following study was accomplished for the potentiation of the lime reduction consumption in clarification. In this Example, synergies of Bentonite NA 35, Clarigel 215 AA, and Radiolite 600 with polyaluminum Chloride (PAC), and its mixtures were studied. Results can be seen in Table 4.

TABLE 4
% Lime reduction results at a Dosing of 0.01% w/w.

| | Average | | Amount of | Average Amount | |
|---|---|---|---|---|---|
| | Clarification | Std. | Lime using | of Lime with | % Lime |
| Sample | vs SO₂ | Deviation | SO₂/ppm | Treatment | Reduction |
| Bentonite NA-35/ | 0.810 | 0.016 | 320 | 143.33 | 55.21 |
| Alupol ® (50/50) | | | | | |
| Bentonite NA-35/ | 0.536 | 0.068 | 305 | 138.33 | 54.64 |
| Clarigel ™ 215/ | | | | | |
| Alupol ® (33/33/33) | | | | | |
| Clarigel ™ 215/ | 0.599 | 0.067 | 350 | 155.00 | 55.71 |
| Alupol ® (50/50) | | | | | |
| Radiolite/ | 0.549 | 0.136 | 380 | 140.00 | 63.16 |
| Alupol ® (50/50) | | | | | |
| Radiolite/ | 0.350 | 0.027 | 340 | 130.00 | 61.76 |
| Clarigel ™ 215/ | | | | | |
| Alupol ® (33/33/33) | | | | | |
| Bentonite NA-35/ | 0.567 | 0.073 | 320 | 116.67 | 63.54 |
| Radiolite 215/ | | | | | |
| Alupol ® (33/33/33) | | | | | |

Studies have shown that the replacement of SO₂ in the clarification of broth samples showed lime economy. That is, in all mixtures of aluminum silicates and aluminum salt, there was a reduction in lime consumption. Among the mixtures tested, the sample mixture of Bentonite NA-35/Radiolite 215/Alupol® (33/33/33) provided a lime reduction of 63.54% when compared with the sulfitation process.

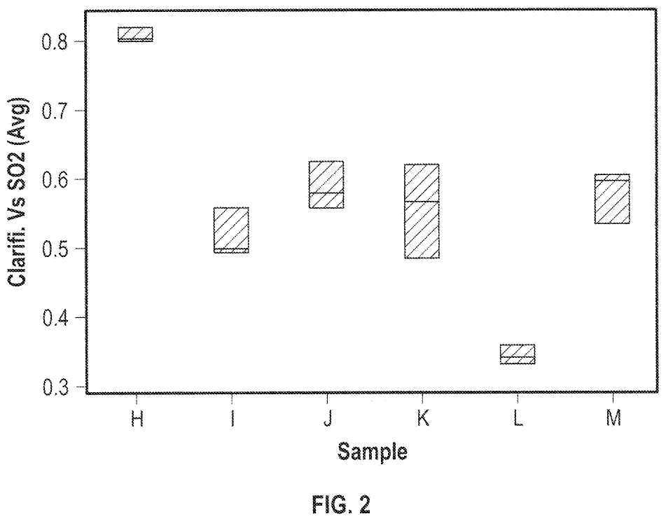

The adsorbent compounds tested in Table 2 were combined with Alupol®, a polyaluminum chloride (PAC) were also tested at a dosage of 0.03% m/m, in the following proportions described in Table 5 and shown in FIG. 2.

TABLE 5
Clarification and Lime Reduction Results of Mixtures dosed at 0.03%.

| | | | | | | Average | |
|---|---|---|---|---|---|---|---|
| | | | % | Clarif. | Amount of | Amount of | |
| | | % Clarif. | Clarif. of | Vs SO₂ | Lime using | Lime after | Lime |
| Sample | % Mixture | w/SO₂ | Sample | (Avg) | SO₂/ppm | Treatment | Reduction |
| H | Bentonite NA- | 41.18 | 33.37 | 0.810 | 320 | 143.33 | 55.21 |
| | 35/Alupol ® | | | | | | |
| | (50/50) | | | | | | |
| I | Bentonite NA- | 48.00 | 25.721 | 0.536 | 305 | 138.33 | 54.64 |
| | 35/Clarigel/Alupol ® | | | | | | |
| | (33.33/33.33/33.33) | | | | | | |
| J | Clarigel/Alupol ® | 52.41 | 31.37 | 0.599 | 350 | 155.00 | 55.71 |
| | (50/50) | | | | | | |
| K | Radiolite/Alupol ® | 46.89 | 25.35 | 0.549 | 380 | 140.00 | 63.16 |
| | (50/50) | | | | | | |
| L | Radiolite/Clarigel/ | 41.12 | 14.40 | 0.350 | 340 | 130.00 | 61.76 |
| | Alupol ® | | | | | | |
| | (33.33/33.33/33.33) | | | | | | |
| M | Bentonite NA- | 45.87 | 26.01 | 0.567 | 320 | 116.67 | 63.54 |
| | 35/Radiolite/Alupol ® | | | | | | |
| | (33.33/33.33/33.33) | | | | | | |

As can be seen in Table 5 and FIG. 2, among the mixtures tested, mixture H (Bentonite NA-35 50%+Alupol® 50%), which is also the same formulation as Sample F of Example 3 (at 0.1% w/w), obtained the best clarity with an average of 0.810±0.016. Samples I, J, K and M provided similar results. Therefore, it is believed that Bentonite NA-35 and Alupol® obtain better synergy when mixed at a dosage of 0.03%.

Also investigated in this study, Samples H, I, J, K, L and M of Table 5 were tested for lime consumption. Lime consumption was reduced by 55.21% using the mixture H in the clarification process when compared with. This reduction can generate savings in the process, since chemical inputs generate a lot of costs for a sugar mill, especially lime that is used in grids quantities.

While at least one exemplary embodiment has been presented in the foregoing detailed description of the inventive subject matter, it should be appreciated that a vast number of variations exist. It should also be appreciated that the exemplary embodiment or exemplary embodiments are only examples, and are not intended to limit the scope, applicability, or configuration of the inventive subject matter in any way. Rather, the foregoing detailed description will provide those skilled in the art with a convenient road map for implementing an exemplary embodiment of the inventive subject matter. It being understood that various changes may be made in the function and arrangement of elements described in an exemplary embodiment without departing from the scope of the inventive subject matter as set forth in the appended claims.

Any references cited in the present application above, including books, patents, published applications, journal articles and other publications, is incorporated herein by reference in their entirety.

What is claimed is:

1. An aqueous sugar-containing composition comprising:
a) an adsorbing compound chosen from keiselguhrs, kaolins, zeolites, montminrollites, attapulgites, palygorskites, bentonites, clays, volcanic ash, and combinations thereof;
b) an inorganic coagulating agent;
c) a plant extract comprising sugar; and
d) water.

2. The composition of claim 1, wherein the adsorbing compound and the inorganic coagulating agent are combined, and the combination is added to the plant extract.

3. The composition of claim 1, wherein the inorganic coagulating agent is chosen from an aluminum salt.

4. The composition of claim 2, wherein the aluminum salt is chosen from aluminum chlorohydrate, aluminum chloride, polyaluminum chloride, or combinations thereof.

5. The composition of claim 3, wherein the aluminum salt is polyaluminum chloride.

6. The composition of claim 1, wherein the adsorbing compound is present in an amount of from about 0.03 wt. % to about 1.0 wt. %, of from about 0.1 wt. % to about 0.9 wt. %, or of from about 0.3 wt. % to about 0.6 wt. %, based on a total weight of the composition; and
the inorganic coagulating agent is present in an amount of from about 0.08 wt. % to about 1.0 wt. % based on a total weight of the composition.

7. The composition of claim 1, wherein the composition is an aqueous suspension, and the adsorbing compound is present in an amount of from about 0.01 wt. % to about 0.6 wt. %, or of from about 0.01 wt. %, to about 0.5 wt. %, or of from about 0.05 wt. % to about 0.3 wt. %, based on a total weight of the composition; and
the inorganic coagulating agent is present in an amount of from about 0.4 wt. % to about 1.0 wt. % based on a total weight of the composition.

8. A method for improved clarification of a plant extract comprising sugar, water, and impurities, said method comprising:
providing the plant extract;
combining the plant extract with
a) an adsorbing compound chosen from keiselguhrs, kaolins, zeolites, montminrollites, attapulgites, palygorskites, bentonites, clays, volcanic ash, and combinations thereof; and
b) an inorganic coagulating agent, to form an aqueous sugar-containing composition; and
separating the impurities from the aqueous sugar-containing composition.

9. The method of claim 8, wherein the adsorbing compound and the inorganic coagulating agent are combined, and the combination is added to the plant extract.

10. The method of claim 8, wherein the inorganic coagulating agent is chosen from an aluminum salt.

11. The method of claim 10, wherein the aluminum salt is chosen from aluminum chlorohydrate, aluminum chloride, polyaluminum chloride, or combinations thereof.

12. The method of claim 11, wherein the aluminum salt is polyaluminum chloride.

13. The method of claim 8, wherein the adsorbing compound is present in an amount of from about 0.03 wt. % to about 1.0 wt. % based on a total weight of the composition; and
the inorganic coagulating agent is present in an amount of from about 0.08 wt. % to about 1.0 wt. %, or from about 0.1 wt. % to about 0.9 wt. %, or of from about 0.3 wt. % to about 0.6 wt. %, based on a total weight of the composition.

14. The method of claim 8, wherein the composition is an aqueous suspension, and the adsorbing compound is present in an amount of from about 0.01 wt. % to about 0.6 wt. % based on a total weight of the composition; and
the inorganic coagulating agent is present in an amount of from about 0.4 wt. % to about 1.0 wt. % based on a total weight of the composition.

15. A method for reducing the amount of lime consumption in the clarification of a sugar-bearing plant extract comprising
a) providing a sugar-bearing extract comprising sugar and water;
b) adding to the sugar-bearing extract a composition comprising: an adsorbing compound chosen from keiselguhrs, kaolins, zeolites, montminrollites, attapulgites, palygorskites, bentonites, clays, volcanic ash, and combinations thereof; and an inorganic coagulating agent.

16. The method according to claim 15, wherein lime consumption is reduced by at least 50 when compared with the consumption of lime using a sulfitation process.
